(19) United States
(12) Patent Application Publication
(10) Pub. No.: US 2015/0201149 A1
(43) Pub. Date: Jul. 16, 2015

(54) DEVICE, METHOD FOR MANAGING VIDEO APPARATUS AND COMPUTER-READABLE MEDIUM

(71) Applicant: VIVOTEK INC., New Taipei (TW)

(72) Inventors: Yi-Hsuen SHIH, New Taipei (TW); Chien-Wen LIU, New Taipei (TW); Ting-Wen CHEN, New Taipei (TW)

(21) Appl. No.: 14/583,924

(22) Filed: Dec. 29, 2014

(30) Foreign Application Priority Data
Jan. 15, 2014 (TW) 103101437

(51) Int. Cl. H04N 5/445; H04N 5/232; H04N 21/2187; H04N 21/4223; H04N 21/472; H04N 7/18; H04N 7/173

(52) U.S. Cl. CPC H04N 5/44591; H04N 7/181; H04N 5/23293; H04N 7/17318; H04N 21/4223; H04N 21/47202; H04N 21/2187

(57) ABSTRACT

A device and a method for managing video apparatuses and a computer-readable medium are provided. The device for managing video apparatuses includes a searching module and a processing module. The searching module is configured to search for a plurality of video apparatuses capable of capturing images. The processing module is configured to select a first sub split-window of a plurality of sub split-windows in a setting interface as an object in association with a first video apparatus of those apparatuses. The processing module also displays at least one image of the first video apparatus on a first main split-window of a plurality of main split-windows. The device for managing video apparatuses can show the association between video apparatuses and main split-windows in the display interface on the setting interface in order to help a user to check and adjust the position of the at least one image.

### CROSS-REFERENCE TO RELATED APPLICATIONS

This non-provisional application claims priority under 35 U.S.C. §119(a) on Patent Application No. 103101437 filed in Taiwan, R.O.C on Jan. 15, 2014, the entire contents of which are hereby incorporated by reference.

### BACKGROUND OF THE INVENTION

1. Technical Field of the Invention

The present invention relates to a device and a method for managing video apparatuses and a computer-readable medium, particularly to a device and a method for managing video apparatuses and a computer-readable medium in which locations of the video apparatuses corresponding to a display interface are obtained from a setting interface.

2. Description of the Related Art

With the increasing emphasis on people's lives and properties, the surveillance systems are not only installed in important institutions or intersections, but also in more and more houses and offices. For example, lots of cameras are set up in a single floor of a commercial building for monitoring any security suspected area by capturing images. In order to facilitate the monitoring staff to observe multiple monitor screens, a split window is needed to collect the monitor screens of a plurality of connected cameras in a display interface.

However, setting multiple monitor screens in a single display interface is not convenient. For example, in a conventional monitoring system, due to the lack of a convenient setting interface, the monitoring staff is not able to directly know the location of a certain camera in the split-window of the display interface. The monitoring staff can only assign the selected monitor screen to a certain split-window or guess the split window corresponding to the selected monitor screen. Therefore, the monitoring staff can only rely on his memory or switch the display interface and the setting interface repeatedly for obtaining the location of the split window and the monitor screen to adjust the location of the monitor screen in the split window. It is very inconvenient when more and more cameras are installed and the monitoring staff needs lots of time to setup.

### SUMMARY

According to the device for managing video apparatuses of the present invention, the device comprises a searching module and a processing module. The searching module is for searching for a plurality of video apparatuses capable of capturing images. The processing module is for selecting a first sub split-window of a plurality of sub split-windows in a setting interface as an object in association with a first video apparatus of the plurality of video apparatuses, and for displaying at least one image of the associated first video apparatus on a first main split-window of a plurality of main split-windows in a display interface. A relative location of the first main split-window of the plurality of main split-windows is corresponding to a relative location of the first sub split-window of the plurality of sub split-windows.

According to the method for managing video apparatuses of the present invention, the method comprises searching for a plurality of video apparatuses capable of capturing images, selecting a first sub split-window of a plurality of sub split-windows in a setting interface as an object in association with a first video apparatus of the plurality of video apparatuses, and displaying at least one image of the associated first video apparatus on a first main split-window of a plurality of main split-windows in a display interface. A relative location of the first main split-window of the plurality of main split-windows is corresponding to a relative location of the first sub split-window of the plurality of sub split-windows.

According to the computer-readable medium of the present invention, the computer-readable medium has computer codes for a processing module to execute a plurality of instructions and the plurality of instructions comprising searching for a plurality of video apparatuses capable of capturing images, selecting a first sub split-window of a plurality of sub split-windows in a setting interface as an object in association with a first video apparatus of the plurality of video apparatuses, and displaying at least one image of the associated first video apparatus on a first main split-window of a plurality of main split-windows in a display interface. A relative location of the first main split-window of the plurality of main split-windows is corresponding to a relative location of the first sub split-window of the plurality of sub split-windows.

The contents of the present invention set forth and the embodiments hereinafter are for demonstrating and illustrating the spirit and principles of the present invention, and for providing further explanation of the claims.

### BRIEF DESCRIPTION OF THE DRAWINGS

The present invention will become more fully understood from the detailed description given hereinbelow and the accompanying drawings, which are given by way of illustration only and thus are not limitative of the present invention and wherein:

FIG. 1 is a functional block diagram of a device for managing video apparatuses according to an embodiment of the present invention.

FIG. 2 is a diagram of a setting interface according to an embodiment of the present invention.

FIG. 3 is a relation diagram of a video apparatus, a NVR, and a display interface according to an embodiment of the present invention.

FIG. 4A is a flowchart of a method for managing video apparatuses according to an embodiment of the present invention.

FIG. 4B is a flowchart of a method for managing video apparatuses according to another embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

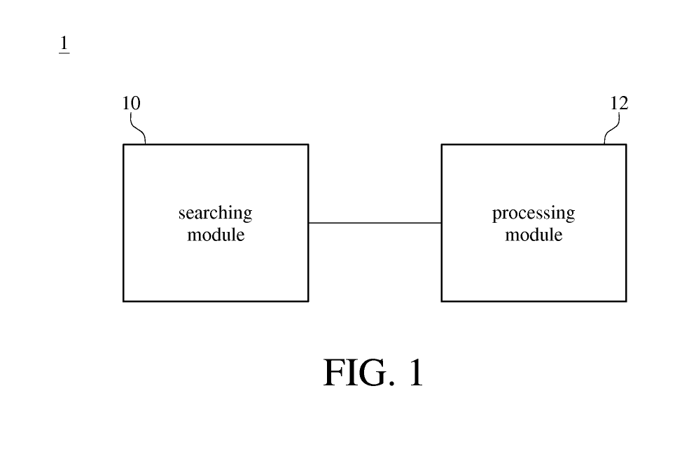

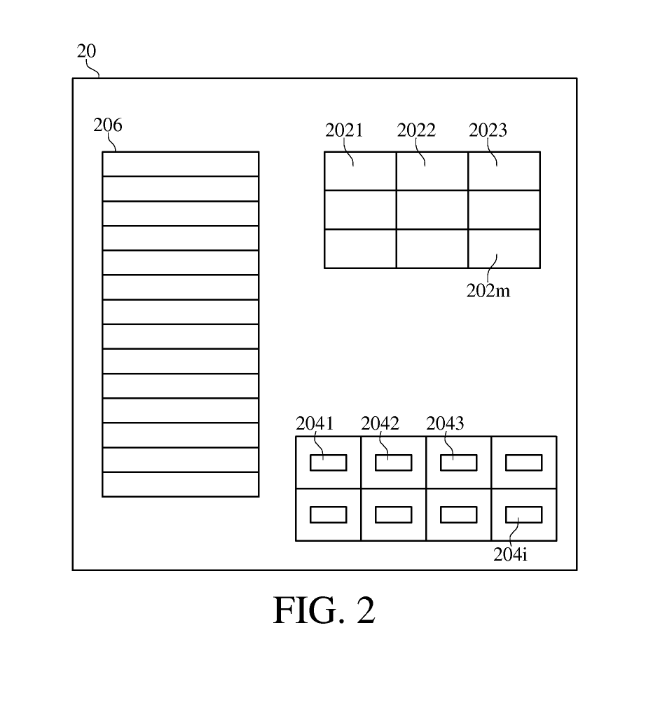

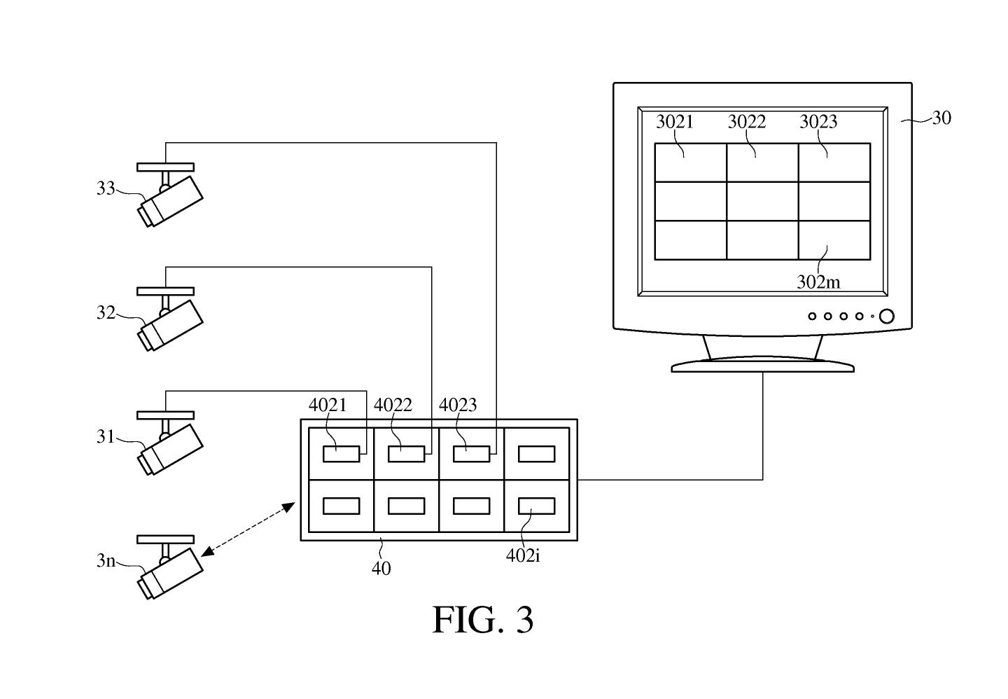

Please refer to FIG. 1, FIG. 2, and FIG. 3 together. FIG. 1 is a functional block diagram of a device for managing video apparatuses according to an embodiment of the present invention. FIG. 2 is a diagram of a setting interface according to an embodiment of the present invention. FIG. 3 is a relation diagram of a video apparatus, a NVR (Network Video Recorder), and a display interface according to an embodiment of the present invention. As shown in FIG. 1, the device for managing video apparatuses 1 has a searching module 10 and a processing module 12. The searching module 10 transmits the data of the video apparatuses 31, 32, 33 . . . 3n to the processing module 12.

The searching module 10 is for searching for a plurality of video apparatuses 31, 32, 33 . . . 3n capable of capturing images. In an embodiment, the searching module 10 obtains the information of the video apparatuses 31, 32, 33 . . . 3n through wireless searching or wired connection. The video apparatuses 31, 32, 33 . . . 3n are traditional cameras, wireless internet protocol (IP) cameras, IP cameras, or any other devices capable of capturing images. The information of the video apparatuses 31, 32, 33 . . . 3n is IP addresses, connection ports, media access control (MAC) addresses, video apparatus numbers, image resolutions, brand names, or any of the properties of the video apparatuses 31, 32, 33 . . . 3n, or the combinations of previous information. The aforementioned embodiment is for illustrating but not for limiting the present invention.

In practice, after the monitoring staff sets up the video apparatus 31, 32, 33 . . . 3n through wireless/wired connection inside the searchable range of the searching module 10, the searching module 10 searches for the video apparatuses 31, 32, 33 . . . 3n and sends the information of the video apparatuses 31, 32, 33 . . . 311 capable of capturing images, such as IP addresses, connection ports, media access control (MAC) addresses, video apparatus numbers, to the processing module 12. The searchable range of the searching module 10 stands for the wireless network transmitting/receiving range of the device for managing the video apparatus 1. For example, when the wireless network transmitting/receiving range of the device for managing video apparatus 1 covers three floors of a building, the searchable range stands for the three floors or all the video apparatuses 31, 32, 33 . . . 3n of the device for managing video apparatus 1 through wired connections.

The processing module 12 is for selecting a first split sub-window of a plurality of split sub-windows 2021, 2022, 2023 . . . 202m in a setting interface 20, for example, the sub split-window 2021, as an object in association with a first video apparatus of the plurality of video apparatuses 31, 32, 33 . . . 3n, for example, the video apparatus 31. It is worth mentioning that the selecting a window as an object in association with a video apparatus indicates building a virtual relationship between the apparatus and the window, such as the object concept in the object-oriented design. The processing module 12 is also for displaying the at least one image of the associated first video apparatus 31 on a first main split-window of a plurality of main split-windows 3021, 3022, 3023 . . . 302m in a display interface 30, such as the main split-window 3021. The display interface 30 is a display. The following description uses the video apparatus 31 to represent the first video apparatus, and the sub split-window 2021 to represent the first sub split-window, and the main split-window 3021 to represent the first main split-window so as to illustrate but not limit the present invention. In practice, the first video apparatus is any of the video apparatuses 31, 32, 33 . . . 3n, and the first sub split-window is any of the sub split-windows 2021, 2022, 2023 . . . 202m, and the first main split-window is any of the main split-windows 3021, 3022, 3023 . . . 302m.

The details of the setting interface 20 are described later. In practice, the setting interface 20 is a webpage or any other page for setting the video apparatus. In practice, the display interface 30 is a monitor of a computer, a smart phone, a tablet, or any other electronic device. Besides, the processing module 12 is a micro processor, a central process unit, or any other unit suitable for arithmetic computing. The aforementioned embodiment is for illustrating but not for limiting the present invention.

The relative location of the main split-window 3021 in the plurality of main split-windows 3021, 3022, 3023 . . . 302m corresponds to the relative location of the sub split-window 2021 in the plurality of sub split-windows 2021, 2022, 2023 . . . 202m. For example, when the arrangements of the plurality of main split-windows 3021, 3022, 3023 . . . 302m and the plurality of sub split-windows 2021, 2022, 2023 . . . 202m are both array types, and the main split-window 3021 is located in the first column and the first row of the plurality of main split-windows 3021, 3022, 3023 . . . 302m, then the corresponding sub split-window 2021 is also located in the first column and the first row of sub split-windows 2021, 2022, 2023 . . . 202m. The main split-window 3022 is located in the first column and the second row of the plurality of main split-windows 3021, 3022, 3023 . . . 302m, then the corresponding sub split-window 2022 is also located in the first column and the second row of sub split-windows 2021, 2022, 2023 . . . 202m, and so forth.

Besides, the window sizes and the position arrangements of each of the main split-windows 3021, 3022, 3023 . . . 302m and each of the sub split-windows 2021, 2022, 2023 . . . 202m are set according to the horizontal/vertical segmentation to represent different window sizes and position arrangements depending on the needs of the monitoring staff.

Next, when the processing module 12 changes the object in association with the first video apparatus 31 from the first sub split-window 2021 to a second sub split-window of the plurality of sub split-windows 2021, 2022, 2023 . . . 202m, the processing module 12 displays the at least one image of the first video apparatus 31 on the second main split-window of the plurality of sub split-windows 2021, 2022, 2023 . . . 202m, such as the main split-window 3022. In the present invention, the sub split-window 2022 represents the second sub split-window and the main split-window 3022 represents the second main split-window in the following explanation. The aforementioned embodiment is for illustrating but not for limiting the present invention. In other words, the second sub split-window is any of the sub split-windows 2022, 2023 . . . 202m except the sub split-window 2021 (the sub split-window 2021 is the first sub split-window), and the second main split-window is any of the main split-windows 3022, 3023 . . . 302m except the main split-window 3021 (the main split-window 3021 is the first main split-window).

Specifically, when the monitoring staff wants to move the image of the first video apparatus 31 in the first main split-window 3021 to the second main split-window 3022, the monitoring staff changes the object in association with the first video apparatus 31 from the first sub split-window 2021 to the second sub split-window 2022 through the sub split-windows 2021, 2022, 2023 . . . 202m in the setting interface 20. The processing module 12 changes the object in association with the first video apparatus 31 from the first sub split-window 2021 to the second sub split-window 2022. In addition, the processing module 12 also displays the at leas one image of the first video apparatus 31 on the second main split-window 3022. The said operations of the sub split-windows 2021, 2022, 2023 . . . 202m are through dragging or clicking any two of the sub split-windows 2021, 2022, 2023 . . . 202m. The aforementioned embodiment is for illustrating but not for limiting the present invention.

Besides, the relative location of the second main split-window 3022 in the plurality of main split-windows 3021, 3022, 3023 . . . 302m and the relative location of the second sub split-window 2022 in the plurality of sub split-windows 2021, 2022, 2023 . . . 202m are described above, and are not further described hereinafter.

In addition, when the object in association with the second video apparatus of the plurality of video apparatuses 31, 32, 33 . . . 3n, such as the video apparatus 32, is the second sub split-window 2022, the processing module 12 changes the object in association with the second video apparatus 32 from the second sub split-window 2022 to the first sub split-window 2021, and the processing module 12 further displays the at least one image of the second video apparatus 32 on the first main split-window 3021 of the plurality of main split-windows. Furthermore, when the monitoring staff further changes the object in association with the video apparatus 31 by operating the sub split-windows 2021, 2022, 2023 . . . 202m, and selects the sub split-window 2022 as the object in association with the video apparatus 31, if the sub split-window 2022 is the previous object in association with another video apparatus 32, the at least one image of the video apparatus 32 is displayed on the main split-window 3022 in the display interface 30, and the processing module 12 changes the object in association with the video apparatus 32 from the sub split-window 2022 to the sub split-window 2021. The processing module 12 displays the at least one image of the video apparatus 32 on the main split-window 3021 of the plurality of main split-windows, so that exchanging the objects in association with the video apparatus 31 and the video apparatus 32 is achieved.

The setting interface 20 further includes a list 206 for displaying the information of the plurality of video apparatuses 31, 32, 33 . . . 3n. In practice, the information of the video apparatuses 31, 32, 33 . . . 3n is IP addresses, connection ports, media access control (MAC) addresses, video apparatus numbers, image resolutions, brand names, or any of the properties of the video apparatuses 31, 32, 33 . . . 3n, or the combinations of previous information. The aforementioned embodiment is for illustrating but not for limiting the present invention.

Next, when the processing module 12 selects the information of the video apparatus 31 in the list 206, a first display block is generated. The first display block displays the information of the sub split-windows 2021, 2022, 2023 . . . 202m or provides the operation option of the association between the video apparatus 31 and the sub split-window 2021. In other words, when the monitoring staff selects the information of the video apparatus 31 in the list 206, the processing module 12 selects the information of the video apparatus 31 in the list 206 and generates a first display block. The first display block is but not limited to a drop-down menu or a plurality of small icons which have the same arrangements with the sub split-windows 2021, 2022, 2023 . . . 202m. The aforementioned embodiment is for illustrating but not for limiting the present invention. The contents of the first display block are the association status of between the sub split-windows 2021, 2022, 2023 . . . 202m and the video apparatuses 31, 32, 33 . . . 3n, or the operation option of the association between the video apparatus 31 and one of the sub split-windows 2021, 2022, 2023 . . . 202m for the monitoring staff.

For example, when the monitoring staff clicks the icon corresponding to the sub split-window 2023 in the first display block, the processing module 12 selects the sub split-window 2023 as the object in association with the video apparatus 31. Besides, the first display block further has a delete icon for the monitoring staff to delete the association between the video apparatus 31 and one of the sub split-windows 2021, 2022, 2023 . . . 202m by clicking the delete icon.

In addition, when the processing module 12 selects the sub split-window 2021, a second display block is generated. The second display block displays the related information of the video apparatuses 31, 32, 33 . . . 3n. Specifically, when the monitoring staff clicks the sub split-window 2021, the processing module 12 selects the sub split-window 2021 and generates the second display block. The second display block is but not limited to a drop-down menu located in the area corresponding to the sub split-window 2021, such as below the sub split-window. The aforementioned embodiment is for illustrating but not for limiting the present invention. The contents of the second display block are the information of all the video apparatuses 31, 32, 33 . . . 3n which are capable of capturing images and searchable by the searching module 10, or the operation option of the association between the sub split-window 2021 and one of the video apparatuses 31, 32, 33 . . . 3n for the monitoring staff.

For example, when the monitoring staff clicks the sub split-window 2021 and further clicks the information of one of the video apparatuses 31, 32, 33 . . . 3n displayed in the second display block, the processing module 12 selects the sub split-window 2021 as the object in association with the video apparatus 3n and further displays the at least one image of the video apparatus 3n on the main split-window 3021 in the display interface 30 corresponding to the sub split-window 2021. Besides, the second display block further has a delete icon for the monitoring staff to delete the association between the sub split-window 2021 and one of the video apparatuses 31, 32, 33 . . . 3n by clicking the delete icon.

In addition to previous description, when the processing module 12 selects the sub split-window 2021, the processing module 12 further generates a third display block, the third display block is for displaying the information of the video apparatus 31 in association with the sub split-window 2021, or for providing the operation option corresponding to the video apparatus 31. For example, when the monitoring staff clicks the sub split-window 2021, the processing module 12 selects the sub split-window 2021 and generates the third display block, the third display block is for displaying the information of the video apparatus 31 in association with the sub split-window 2021, such as the network video apparatus number and the image resolution of the video apparatus 31. Furthermore, the monitoring staff is also able to change the settings of the video apparatus 31 through the third display block. For example, the monitoring staff changes the resolution of the video apparatus 31 from 800×600 to 640×480 through the third display block. The design depends on the need of the monitoring staff. The aforementioned embodiment is for illustrating but not for limiting the present invention.

In addition to the previous embodiment, the setting interface 20 further includes a plurality of graphical blocks 2041, 2042, 2043 . . . 204i, and the relative location of each of the plurality of graphical blocks 2041, 2042, 2043 . . . 204i corresponds to the relative location of each of a plurality of slots 4021, 4022, 4023 . . . 402i. For example, the location of the graphical block 2041 in the plurality of graphical blocks 2041, 2042, 2043 . . . 204i is in the first column and the first row, so the location of the corresponding slot 4021 in the plurality of slots 4021, 4022, 4023 . . . 402i is in the first column and the first row. The relations between other graphical blocks and slots are similar.

Next, when the processing module 12 detects that the sub split-window 2021 is selected, if the video apparatus 31 in association with the sub split-window 2021 is coupled with one of the plurality of slots 4021, 4022, 4023 . . . 402i, such as the slot 4021, the graphical block 2041, 2042, 2043 . . . 204i corresponding to the coupled slot 4021, such as the graphical block 2041, is displayed distinctively on the setting interface 20. For example, when the monitoring staff clicks the sub split-window 2021, the processing module 12 determines whether the video apparatus 31 in association with the sub split-window 2021 is wiredly connected with one of the slots 4021, 4022, 4023 . . . 402i of the NVR 40. If yes, the processing module 12 displays the graphical block 2041 corresponding to the slot 4021 on the setting interface 20 in an obvious way, such as illumination. The aforementioned embodiment is for illustrating but not for limiting the present invention.

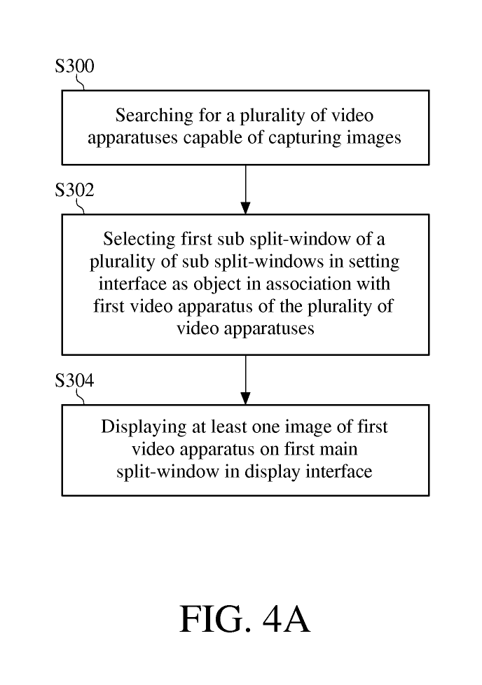

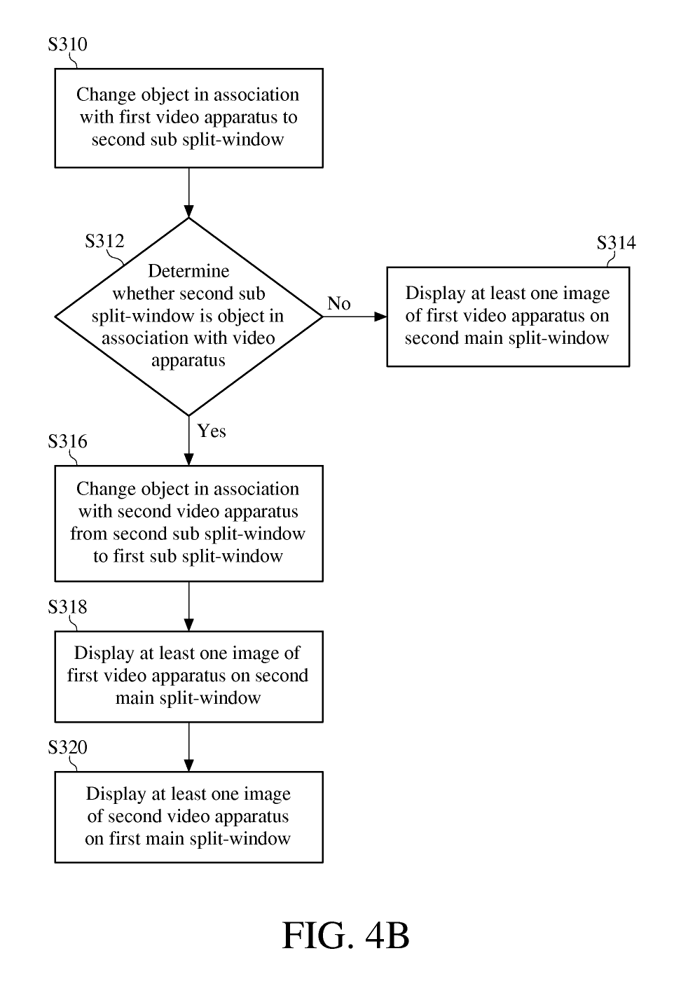

In order to make persons skilled in the art to understand the multimedia managing device of the present invention more, the following description is explained with the multimedia managing method of the present invention. Please refer to FIG. 1, FIG. 2, FIG. 3, and FIG. 4A together. FIG. 4A is a flowchart of a method for managing video apparatuses according to an embodiment of the present invention. As shown in the figures, in the step S300, the searching module 10 searches for a plurality of video apparatuses 31, 32, 33 . . . 3n capable of capturing images. In the step S302, the processing module 12 selects the sub split-window 2021 in the setting interface 20 as the object in association with the video apparatus 31 of the plurality of video apparatuses 31, 32, 33 . . . 3n. In the step S304, the processing module 12 displays the at least one image of the video apparatus 31 on the main split-windows 3021 in the display interface 30. The relative locations of the plurality of main split-windows 3021, 3022, 3023 . . . 302m in the setting interface 20 corresponds to the relative locations of the plurality of sub split-windows 2021, 2022, 2023 . . . 202m.

Besides, please refer to FIG. 1, FIG. 2, FIG. 3, and FIG. 4B together. FIG. 4B is a flowchart of a method for managing video apparatuses according to another embodiment of the present invention. As shown in the figures, in the step S310, the processing module 12 changes the association between the video apparatus 31 and the sub split-window 2022. In the step S312, the processing module 12 determines whether the sub split-window 2022 is associated. In the step S314, because the sub split-window 2022 is not in association with other video apparatuses 32, 33 . . . 3n, the processing module 12 selects the sub split-window 2022 as the object in association with the video apparatus 31 and displays the at least one image of the video apparatus 31 on the main split-window 3022.

In the step S316, because the sub split-window 2022 is in association with another video apparatus 32, the processing module 12 changes the object in association with the video apparatus 32 from the sub split-window 2022 to the sub split-window 2021, and selects the sub split-window 2022 as the object in association with the video apparatus 31. In the step S318, the processing module 12 displays the at least one image of the video apparatus 31 on the main split-window 3022. In the step S320, the processing module 12 displays the at least one image of the video apparatus 32 on the main split-window 3021. It is worth mentioning that the order of step S318 to step S320 is interchangeable. For example, in the step S318, the processing module 12 displays the at least one image of the video apparatus 32 on the main split-window 3021, and in the step S320, the processing module 12 displays the at least one image of the video apparatus 31 on the main split-window 3022.

In addition to the previous explanation, the present invention further includes a computer-readable medium for the processing module 12 to execute a plurality of instructions in the computer codes. The instructions are specifically explained in each of the previous embodiments of the method for managing video apparatuses and are not further described hereinafter.

The present invention is explained with an example here. When the monitoring staff finishes the setting of a plurality of video apparatuses 31, 32, 33 . . . 3n, the device for managing video apparatuses 1 obtains the information of all of the plurality of video apparatuses 31, 32, 33 . . . 3n capable of capturing images through the searching module 10 and sends the information to the setting interface 20. The setting interface 20 displays the information with the form of the list 206. The monitoring staff obtains the information of the plurality of video apparatuses 31, 32, 33 . . . 3n through the list 206 on the setting interface 20. When the monitoring staff clicks the information of one of the plurality of video apparatuses 31, 32, 33 . . . 3n on the list 206, the processing module 12 generates a display block, and the display block is for providing the monitoring staff to check the image of the video apparatuses and the association between the main split-windows 3021, 3022, 3023 . . . 302m and the video apparatuses 31, 32, 33 . . . 3n on the display interface 30. The video apparatuses are displayed in the display block using small icons. When the monitoring staff clicks one of the small icons, the processing module 12 selects the corresponding sub split-window 2021 as the object in association with the clicked video apparatus 31 and the processing module 12 displays the at least one image of the video apparatus 31 on the corresponding main split-window 3021.

Furthermore, the monitoring staff also clicks one of the sub split-windows 2021, 2022, 2023 . . . 202m to display the other two display blocks. One of the display blocks displays the information of video apparatuses 31, 32, 33 . . . 3n in association with the sub split-windows 2021, 2022, 2023 . . . 202m. In addition, the monitoring staff also operates the setting options of changing the video apparatuses 31, 32, 33 . . . 3n in the display block, such as changing the resolution or name of the video apparatuses 31, 32, 33 . . . 3n . . . etc. Another display block displays all of the video apparatuses 31, 32, 33 . . . 3n searched by the searching module 10, and when the monitoring staff clicks the video apparatus 31 in the display block, the processing module 12 selects the sub split-window 2021 as the object in association with the video apparatus 31 clicked by the monitoring staff. Also, the processing module 12 displays the at least one image of the clicked video apparatus 31 on the corresponding main split-window 3021.

When the monitoring staff wants to change the location of the image of the video apparatus 31 in the main split-windows 3021, 3022, 3023 . . . 302m, the monitoring staff drags the sub split-window 2021 of the plurality of sub split-windows 2021, 2022, 2023 . . . 202m to another sub split-window 2022, and the processing module 12 respectively exchanges the object in association with the video apparatuses 31, 32 with the sub split-windows 2021, 2022, and the processing module 12 also interchangeably displays the at least one image of the two video apparatuses 31, 32 on the main split-windows 3022, 3021, so that the locations of images of the video apparatuses 31, 32 is changed. When the monitoring staff wants to delete the association between the sub split-window 2021 and the video apparatus 32, he just clicks the sub split-window 2021 and selects the delete option in the display block.

Next, the setting interface 20 further includes a plurality of graphical blocks 2041, 2042, 2043 . . . 204i. The plurality of graphical blocks 2041, 2042, 2043 . . . 204i correspond to the slots 4021, 4022, 4023 . . . 402i on the NVR 40. When the monitoring staff clicks the sub split-window 2022, if the video apparatus 31 in association with the clicked sub split-window 2022 is coupled with the slot 4021 of the slots 4021, 4022, 4023 . . . 402i, the graphical block 2041 corresponding to the coupled slot 4021 illuminates on the setting interface 20, so that the monitoring staff easily understands that the video apparatus 31 is connected to the slot 4021 of the NVR 40 and knows the location.

In summary, the present invention helps the monitoring staff to know that the image of the video apparatus are displayed on the corresponding main split-window through the sub split-window in the setting interface by the plurality of video apparatuses capable of capturing images, the association between the video apparatus and the plurality of sub split-windows in the setting interface, and the images of the associated video apparatuses are displayed on the corresponding main split-windows in the display interface. Also, the monitoring staff adds, deletes, or modifies the locations of the displayed images of the video apparatuses in the main split-windows through operating on these sub split-windows. Moreover, the setting interface of the present invention further has a plurality of graphical blocks, wherein each of the graphical blocks is corresponding to a location of a slot on the NVR. The graphical blocks of the setting interface are for the monitoring staff to determine the coupled relations between the video apparatuses and the slots of the NVR easily.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

What is claimed is:

1. A method for managing video apparatuses, comprising:
searching for a plurality of video apparatuses capable of capturing images;
selecting a first sub split-window of a plurality of sub split-windows in a setting interface as an object in association with a first video apparatus of the plurality of video apparatuses; and
displaying at least one image of the associated first video apparatus on a first main split-window of a plurality of main split-windows in a display interface;
wherein a relative location of the first main split-window of the plurality of main split-windows is corresponding to a relative location of the first sub split-window of the plurality of sub split-windows.

2. The method for managing video apparatuses of claim 1, further comprising displaying the at least one image of the first video apparatus on a second main split-window of the plurality of main split-windows when the object in association with the first video apparatus is changed from the first sub split-window to the second sub split-window of the plurality of sub split-windows, wherein the relative location of the second main split-window of the plurality of main split-windows is corresponding to the relative location of the second sub split-window of the plurality of sub split-windows.

3. The method for managing video apparatuses of claim 2, wherein when the second sub split-window is the object in association with the second video apparatus of the plurality of video apparatuses, the object in association with the second video apparatus is changed from the second sub split-window to the first sub split-window, and the at least one image of the second video apparatus is displayed on the first main split-window of the plurality of main split-windows.

4. The method for managing video apparatuses of claim 1, wherein the setting interface further comprises a list, and the list shows the information of the plurality of video apparatuses, and when the information of the first video apparatus in the list is selected, a first display block is generated, and the first display block displays the information of the plurality of sub split-windows or provides an operation option of the association between the first video apparatus and the first sub split-window.

5. The method for managing video apparatuses of claim 1, wherein when the first sub split-window is selected and a second display block is generated, and the second display block displays the information of the plurality of video apparatuses.

6. The method for managing video apparatuses of claim 1, wherein when the first sub split-window is selected and a third display block is generated, the third display block displays the information of the first video apparatus in association with the first sub split-window or provides an operation option corresponding to the video apparatus.

7. The method for managing video apparatuses of claim 1, wherein the setting interface further comprises a plurality of graphical blocks and a relative location of each of the plurality of graphical blocks corresponds to a relative location of each of the slots in a NVR (Network Video Recorder).

8. The method for managing video apparatuses of claim 7, wherein when the first sub split-window is selected, if the first video apparatus in association with the first sub split-window is coupled with one of the slots, the graphical block corresponding to the coupled slot is distinctively displayed to the setting interface.

9. A device for managing video apparatuses, comprising:
a searching module for searching for a plurality of video apparatuses capable of capturing images; and
a processing module for selecting a first sub split-window of a plurality of sub split-windows in a setting interface as an object in association with a first video apparatus of the plurality of video apparatuses, and for displaying at least one image of the associated first video apparatus on a first main split-window of a plurality of main split-windows in a display interface;
wherein a relative location of the first main split-window of the plurality of main split-windows is corresponding to a relative location of the first sub split-window of the plurality of sub split-windows.

10. The device for managing video apparatuses of claim 9, wherein when the processing module changes the object in association with the first video apparatus from the first sub split-window to a second sub split-window of the plurality of sub split-windows, the processing module displays the at least one image of the first video apparatus on the second main split-window of the plurality of main split-windows, and the relative location of the second main split-window of the plurality of main split-windows is corresponding to the relative location of the second sub split-window of the plurality of sub split-windows.

11. The device for managing video apparatuses of claim 10, wherein when the second sub split-window is the object in association with the second video apparatus of the plurality of video apparatuses, the processing module changes the object in association with the second video apparatus from the second sub split-window to the first sub split-window, and the processing module displays the at least one image of the second video apparatus on the first main split-window of the plurality of main split-windows.

12. The device for managing video apparatuses of claim 9, wherein the setting interface further comprises a list, and the list shows the information of the plurality of video apparatuses, and when the processing module selects the information of the first video apparatus in the list, a first display block is generated, and the first display block displays the information of the plurality of sub split-windows or provides an operation option of the association between the first video apparatus and the first sub split-window.

13. The device for managing video apparatuses of claim 9, wherein when the processing module selects the first sub split-window and the processing module generates a second display block, and the second display block displays the information of the plurality of video apparatuses.

14. The device for managing video apparatuses of claim 9, wherein when the processing module selects the first sub split-window and the processing module generates a third display block, the third display block displays the information of the first video apparatus in association with the first sub split-window or provides an operation option corresponding to the video apparatus.

15. The device for managing video apparatuses of claim 9, wherein the setting interface further comprises a plurality of graphical blocks and a relative location of each of the plurality of graphical blocks corresponds to a relative location of each of the slots in a NVR.

16. The device for managing video apparatuses of claim 15, wherein when the processing module detects that first sub split-window is selected, if the first video apparatus in association with the first sub split-window is coupled with one of the slots, the graphical block corresponding to the coupled slot is distinctively displayed to the setting interface.

17. A computer-readable medium, having computer codes for a processing module to execute a plurality of instructions and the plurality of instructions comprising the method for managing video apparatuses of claim 1.
